(19) United States
(12) Patent Application Publication
(10) Pub. No.: US 2019/0203894 A1
(43) Pub. Date: Jul. 4, 2019

(54) DOWNLIGHT APPARATUS

(71) Applicant: XIAMEN ECO LIGHTING CO. LTD., Xiamen (CN)

(72) Inventors: Maojin Zeng, XIAMEN (CN); Hao Luo, XIAMEN (CN)

(21) Appl. No.: 16/240,144

(22) Filed: Jan. 4, 2019

(30) Foreign Application Priority Data
Jan. 4, 2018 (CN) 201820011126.2

(51) Int. Cl. F21S 8/02; F21V 15/01; F21V 17/10; F21V 17/16; F21V 21/04; F21V 29/70

(52) U.S. Cl. CPC F21S 8/026; F21V 15/01; F21V 17/108; F21Y 2115/10; F21V 17/164; F21V 21/04; F21V 29/70; F21V 17/162

(57) ABSTRACT

A downlight apparatus includes a light source plate, a main housing, a driver circuit and a driver box. The main housing has surface rim and a light source container. The light source container contains the light source plate. The driver box contains the driver circuit and mounted above the light source plate. The driver box is made of plastic material and does not cover the top part of the light source container completely.

### FIELD

The present invention is related to a downlight apparatus and more particularly related to a downlight apparatus with detachable driver box.

### BACKGROUND

Downlight devices are widely used in the world, but people still look for better design with low cost and better visual effect.

Therefore, in such crowded art, any improvement may bring great advantages for human life.

### SUMMARY OF INVENTION

According to an embodiment of the present invention, a downlight apparatus includes a light source plate, a main housing, a driver circuit and a driver box.

The main housing has a surface rim and a light source container. The surface rim defines a light opening and the light source plate is contained in the light source container. For example, the surface rim is a part that engages surface of the ceiling and expose the light opening while the light source container is installed in a cavity of the ceiling.

The light source plate is mounted with a plurality of LED chips. The light of the LED chips is emitted outside the downlight apparatus via the light opening. There may be a lens or a diffuser covering and protecting the light source plate while allowing light to pass through.

The light source container has a lateral wall and a top part. In some embodiments, the light source container is like a cup with a narrow top close to the light source plate and a broader bottom that is close to the light opening.

The top part of the light source container may be a circular shape.

The driver circuit is used for converting an external power source to a driving current to the LED chips of the light source plate. There may be further circuit like wireless circuits to be integrated with the driver circuit so that the downlight apparatus may be controlled by an external device like a mobile phone wirelessly.

The driver box has a side wall, a bottom plate and a top cover. The side wall, the bottom plate and the top cover together defines a driver space for containing the driver circuit. The side wall and the bottom plate are formed as a unibody structure, e.g. being made using a molding process. The top cover may have a hinge connected to the side wall so as to be manually rotatable with respect to the side wall to either expose the driver space or seal the driver space. For example, the side wall may have two rotating holes on opposite sides while the back cover has two corresponding levers disposed in the rotating holes so that the top cover is rotatable with respect to the side wall.

In some embodiments, the driver box is made of plastic material. The bottom plate of the driver box is fixed to the top part of the light source container. A first hole is disposed at the bottom plate and a second hole is disposed at the top part of the light source container. A conductive path is passing through the first hole and the second hole for electrically connecting the driver circuit to the LED chips.

In some embodiments, the side wall of the driver box has a fixing hole and the top cover of the driver box has a hook. The hook is inserted to the fixing hole to close the driver space of the driver box. Specifically, the hook is a locking structure to lock the top cover with respect to the side wall to seal the driver space.

In some embodiments, the hook has a pair of elastic clips for elastically inserting into the fixing hole.

In some embodiments, the bottom plate of the driver box does not have the same shape as the top part of the light source container. For example, the bottom plate is a rectangular shape while the top part of the light source container is a circular shape.

In some embodiments, the bottom plate of the driver box does not completely cover the top part of the light source container so as to expose a portion of the top part of the light source container. With such design, some part of the heat generated by the light source plate may be capable of being transmitted outside without being covered by the driver box.

In some embodiments, the lateral wall of the light source container has a fixing structure for installing a pair of elastic structures to fix the downlight apparatus to a ceiling. For example, two elastic springs may be used as the elastic structures. The two elastic springs are installed and fixed to two grooves on the lateral wall of the light source container.

In some embodiments, the side wall of the driver box has a round corner, which may be safer while people use and install such downlight apparatus.

In some embodiments, the top part of the light source container has an alignment structure to be aligned with the driver box. For example, the top part of the light source container may have at least one aligning hole corresponding to aligning protruding blocks on the bottom plate of the driver box facing to the top part of the light source container.

In some embodiments, the conductive path may have a plugging structure for electrically connecting the driver circuit to the LED chips by plugging. For example, the driver circuit has two pins protruding outside the driver box for plugging two elastic sockets that clip and electrically connected to the LED chips on the light source plate.

In some embodiments, the driver box is detachable to be replaced with another different driver box. For different design requirements, e.g. different height of ceiling cavity, the driver box may be replaced with another size or shape, by detaching an original driver box to be replaced with another driver box.

In some embodiments, the top cover has two levers sliding within two corresponding grooves of the side wall of the driver box when the top cover is rotated with respect to the side wall.

In some embodiments, the downlight apparatus may also include a wire fixing structure disposed on the side wall of the driver box for fixing a wire connected to the driver circuit and extends outside the driver box. The wire fixing structure help fix the wire so that the wire is not easily moved and cause damage.

In some embodiments, the wire fixing structure is a separate component plugging into a socket of the side wall of the driver box. Specifically, the wire fixing is another component that can be installed to the side wall of the driver box. For example, the driver box may have a U shape opening for installing and receiving the wire fixing structure. There may be more than one wire fixing structures disposed on the side wall of the driver box.

In some embodiments, the wire fixing structure has an elastic clip for clipping the wire to prevent the wire to move with respect to the driver box.

In some embodiments, the downlight apparatus also has a heat sink attached on the side wall extended to the lateral wall of the light source container. For example, a metal heat sink is partly engaging the side wall of the driver box and partly engaging the lateral wall of the light source container.

In some embodiments, the main housing is made of plastic material. Furthermore, in some embodiments, the main housing is made of the same material as the driver box.

In some embodiments, the light source plate is fixed to a bottom side of the top part of the light source plate.

In some embodiments, the driver box further contains a wireless circuit. The wireless circuit and the driver circuit are disposed on two circuit boards.

### BRIEF DESCRIPTION OF DRAWINGS

FIG. 1 is an exploded view of a downlight embodiment.

FIG. 2 illustrates a first status of the downlight embodiment.

FIG. 3 illustrates another view of the downlight embodiment.

FIG. 4 illustrates a second status of the downlight embodiment.

FIG. 5 illustrates another view of the downlight embodiment.

FIG. 6 illustrates an example of the driver box.

### DETAILED DESCRIPTION

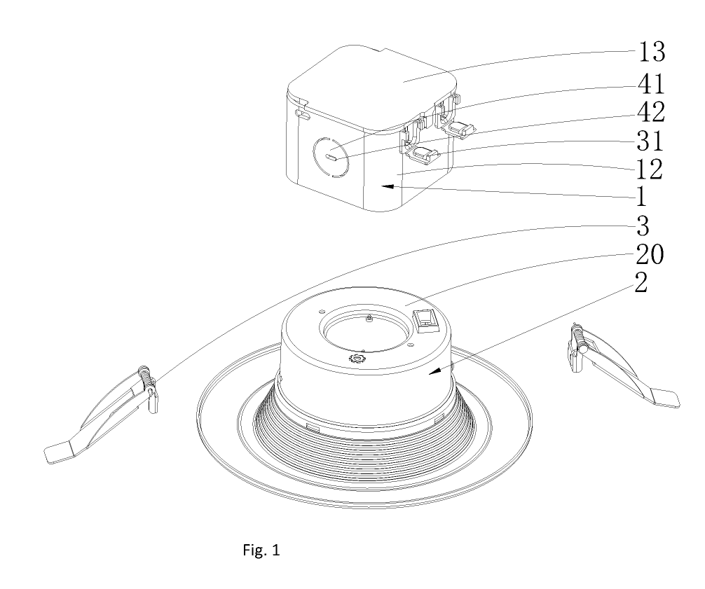

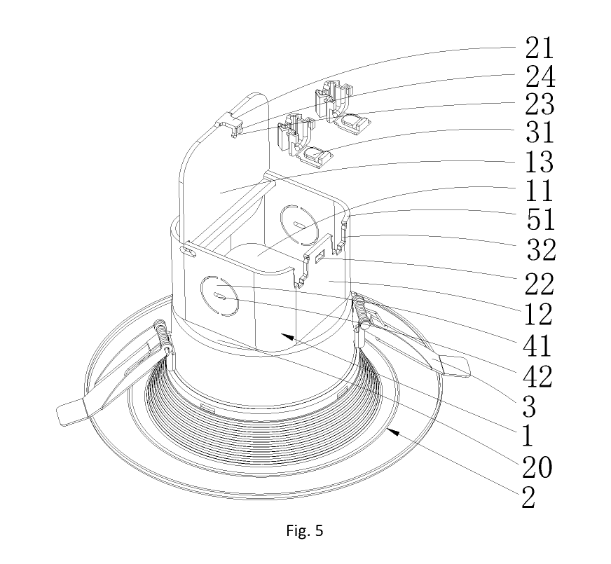

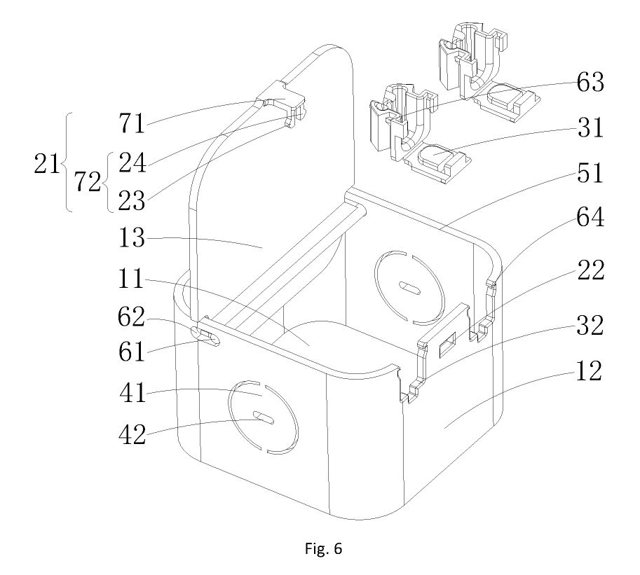

Please refer to FIG. 1, FIG. 5 and FIG. 6, which illustrate a downlight apparatus embodiment.

The downlight includes a main housing 2. The main housing has a light opening (not shown) and a light source container 20 for containing a light source plate (not shown). The light source plate is mounted with LED chips that emit light through the light opening to outside. A driver box 1 is stacked above the main housing 2. A driver circuit is placed in the driver box. The driver box 1 includes a bottom plate 11, a side wall 12 and a top cover 13. The bottom plate 11 and the side wall 12 may be formed at the same time as a unibody structure, e.g. via the same molding structure.

The top cover 13 is connected to the side wall 12 and is rotatable with respect to the side wall 12. There is a box opening 51 covered by the top cover 13. When the top cover 13 is rotated, the box opening 51 is exposed so that users may place a driver circuit inside the driver box 1.

The bottom plate 11 is fixed to a top part of the light source container 20.

In this example, the bottom plate 11 has a smaller area than the top part of the light source container 20 so that the top part of the light source container 20 may have an area not covered by the driver box 1 so as to enhance heat dissipation of the heat generated by the light source plate.

The driver box 1, the main housing 2 and the light source plate are installed aligning with the same axis.

Preferably, the driver box 1 is made of plastic material that is able to resist certain fire accident. Furthermore, the driver box may be made of electric insulation material to prevent accident during installing the downlight apparatus.

The driver box 1 may be made of PA, PC, PP, PBT, PET, PS, ABS and further mixed with anti-fire material or coloring material.

For example, the plastic material is qualified passing UL certificate, F1 certificate, anti-fire for 0.75 mm-3 mm 5VA, over 750 degree temperature testing, RTI more than 100 degree temperature.

The thickness of the driver box 1 is between 1 to 3 mm.

The downlight apparatus is easy to be installed and has low cost advantage while providing sufficient safety requirements.

Please refer to FIG. 6. In FIG. 6, the top cover 13 and the side wall 12 have first block 61 and a first groove 62. The first block 61 is rotatable in the first groove 62.

The first block 61 may be a circular column shape. The first groove 62 may be a circular groove, a hole, an elongated opening or any other hole style.

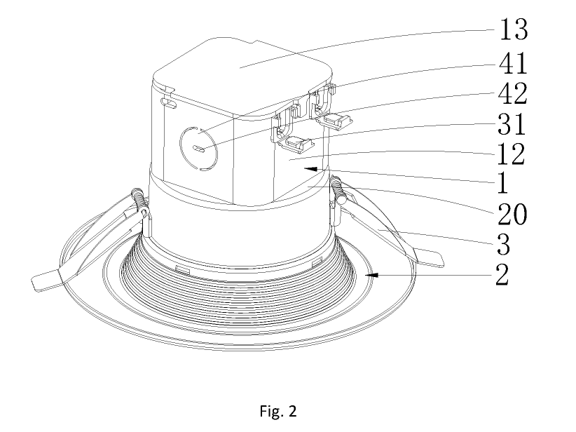

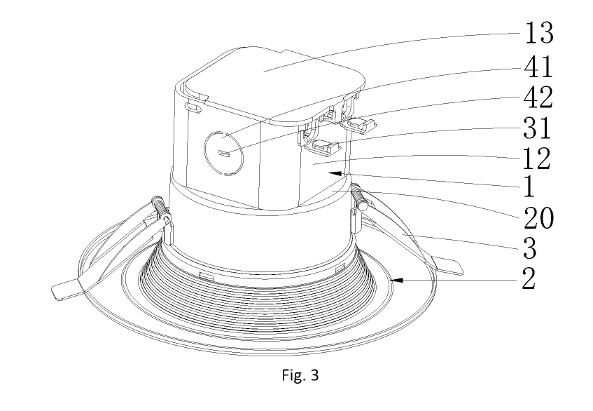

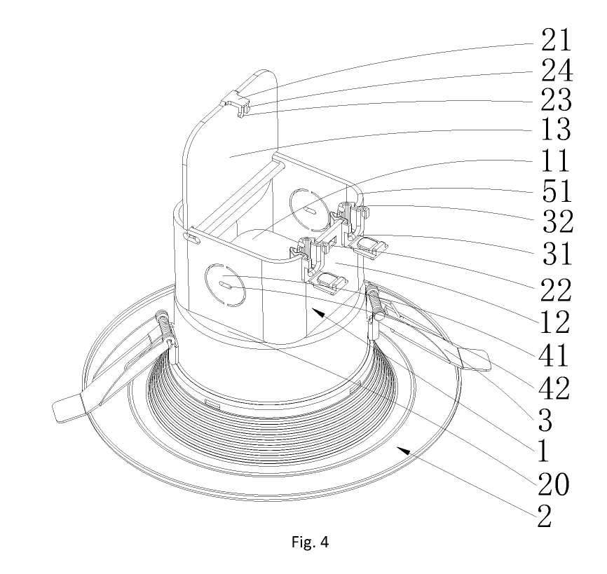

Please refer to FIG. 2 to FIG. 4.

The top cover 13 has an inverse hook 21 corresponding to an installation hole 22 to enhance concealment of the driver box 1.

Please refer to FIG. 6, the end width of the inverse hook 21 is a little larger than other part of the inverse hook 21 so that an end of the inverse hook 21 is squeezed and then hooked in the installation hole 22.

In FIG. 6, the first groove 61 is an elongated opening. The inverse hook 21 includes a first pin 71 and a second pin 72. The first pin 71 is connected to the top cover 13 and the second pin 72 is extended toward inside of the driver box 1.

In this example, the second pin 72 includes a left inverse hook 23 and a right inverse hook 24. There is a gap between the left inverse hook 23 and the right inverse hook 24 so that the second pin 72 is shrunk during inserting to the installation hole.

Please refer to FIG. 2 to FIG. 4. The downlight apparatus may also have a wire fixing structure 31. There is an installation socket 32 disposed on the side wall 12.

In FIG. 6, the installation socket 32 has a corresponding shape as the wire fixing structure 31.

The wire fixing structure has two protruding structures 63 on two opposite sides. The protruding structures 63 correspond to two grooves 64 of the installation socket 32.

In FIG. 5, the side wall 12 has a reserved wire hole 41 for connecting more wires. There is a thin hole 42 so that users may easily open the reserved wire hole 41.

The driver box 1 has a round corner to prevent hurting the users. The radius of the round corner may be between 1 mm to 0.05 mm, e.g. 0.1 mm.

In FIG. 1 and FIG. 2, there may be two elastic fixing structures like the elastic spring 3 disposed on two sides of the lateral wall of the light source container.

According to an embodiment of the present invention, a downlight apparatus includes a light source plate, a main housing, a driver circuit and a driver box.

The main housing has a surface rim and a light source container. The surface rim defines a light opening and the light source plate is contained in the light source container. For example, the surface rim is a part that engages surface of the ceiling and expose the light opening while the light source container is installed in a cavity of the ceiling.

The light source plate is mounted with a plurality of LED chips. The light of the LED chips is emitted outside the downlight apparatus via the light opening. There may be a lens or a diffuser covering and protecting the light source plate while allowing light to pass through.

The light source container has a lateral wall and a top part. In some embodiments, the light source container is like a cup with a narrow top close to the light source plate and a broader bottom that is close to the light opening.

The top part of the light source container may be a circular shape.

The driver circuit is used for converting an external power source to a driving current to the LED chips of the light source plate. There may be further circuit like wireless circuits to be integrated with the driver circuit so that the downlight apparatus may be controlled by an external device like a mobile phone wirelessly.

The driver box has a side wall, a bottom plate and a top cover. The side wall, the bottom plate and the top cover together defines a driver space for containing the driver circuit. The side wall and the bottom plate are formed as a unibody structure, e.g. being made using a molding process. The top cover may have a hinge connected to the side wall so as to be manually rotatable with respect to the side wall to either expose the driver space or seal the driver space. For example, the side wall may have two rotating holes on opposite sides while the back cover has two corresponding levers disposed in the rotating holes so that the top cover is rotatable with respect to the side wall.

In some embodiments, the driver box is made of plastic material. The bottom plate of the driver box is fixed to the top part of the light source container. A first hole is disposed at the bottom plate and a second hole is disposed at the top part of the light source container. A conductive path is passing through the first hole and the second hole for electrically connecting the driver circuit to the LED chips.

In some embodiments, the side wall of the driver box has a fixing hole and the top cover of the driver box has a hook. The hook is inserted to the fixing hole to close the driver space of the driver box. Specifically, the hook is a locking structure to lock the top cover with respect to the side wall to seal the driver space.

In some embodiments, the hook has a pair of elastic clips for elastically inserting into the fixing hole.

In some embodiments, the bottom plate of the driver box does not have the same shape as the top part of the light source container. For example, the bottom plate is a rectangular shape while the top part of the light source container is a circular shape.

In some embodiments, the bottom plate of the driver box does not completely cover the top part of the light source container so as to expose a portion of the top part of the light source container. With such design, some part of the heat generated by the light source plate may be capable of being transmitted outside without being covered by the driver box.

In some embodiments, the lateral wall of the light source container has a fixing structure for installing a pair of elastic structures to fix the downlight apparatus to a ceiling. For example, two elastic springs may be used as the elastic structures. The two elastic springs are installed and fixed to two grooves on the lateral wall of the light source container.

In some embodiments, the side wall of the driver box has a round corner, which may be safer while people use and install such downlight apparatus.

In some embodiments, the top part of the light source container has an alignment structure to be aligned with the driver box. For example, the top part of the light source container may have at least one aligning hole corresponding to aligning protruding blocks on the bottom plate of the driver box facing to the top part of the light source container.

In some embodiments, the conductive path may have a plugging structure for electrically connecting the driver circuit to the LED chips by plugging. For example, the driver circuit has two pins protruding outside the driver box for plugging two elastic sockets that clip and electrically connected to the LED chips on the light source plate.

In some embodiments, the driver box is detachable to be replaced with another different driver box. For different design requirements, e.g. different height of ceiling cavity, the driver box may be replaced with another size or shape, by detaching an original driver box to be replaced with another driver box.

In some embodiments, the top cover has two levers sliding within two corresponding grooves of the side wall of the driver box when the top cover is rotated with respect to the side wall.

In some embodiments, the downlight apparatus may also include a wire fixing structure disposed on the side wall of the driver box for fixing a wire connected to the driver circuit and extends outside the driver box. The wire fixing structure help fix the wire so that the wire is not easily moved and cause damage.

In some embodiments, the wire fixing structure is a separate component plugging into a socket of the side wall of the driver box. Specifically, the wire fixing is another component that can be installed to the side wall of the driver box. For example, the driver box may have a U shape opening for installing and receiving the wire fixing structure. There may be more than one wire fixing structures disposed on the side wall of the driver box.

In some embodiments, the wire fixing structure has an elastic clip for clipping the wire to prevent the wire to move with respect to the driver box.

In some embodiments, the downlight apparatus also has a heat sink attached on the side wall extended to the lateral wall of the light source container. For example, a metal heat sink is partly engaging the side wall of the driver box and partly engaging the lateral wall of the light source container.

In some embodiments, the main housing is made of plastic material. Furthermore, in some embodiments, the main housing is made of the same material as the driver box.

In some embodiments, the light source plate is fixed to a bottom side of the top part of the light source plate.

In some embodiments, the driver box further contains a wireless circuit. The wireless circuit and the driver circuit are disposed on two circuit boards.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

1. A downlight apparatus, comprising:
a light source plate mounted with a plurality of LED chips;
a main housing with surface rim and a light source container, the surface rim defining a light opening and the light source container containing the light source plate, the light source plate emitting a light through the light opening, the light source container having a lateral wall and a top part;
a driver circuit for converting an external power source to a driving current to the LED chips of the light source plate;
a driver box having a side wall, a bottom plate and a top cover together defining a driver space, the side wall and the bottom plate are formed as a unibody structure, the top cover having a hinge connected to the side wall so as to be manually rotatable with respect to the side wall to either expose the driver space or seal the driver space,
wherein the driver box is made of plastic material, the bottom plate of the driver box is fixed to the top part of the light source container, a first hole is disposed at the bottom plate and a second hole is disposed at the top part of the light source container, a conductive path is passing through the first hole and the second hole for electrically connecting the driver circuit to the LED chips.

2. The downlight apparatus of claim 1, wherein the side wall of the driver box has a fixing hole and the top cover of the driver box has a hook, the hook is inserted to the fixing hole to close the driver space of the driver box.

3. The downlight apparatus of claim 2, wherein the hook has a pair of elastic clips for elastically inserting into the fixing hole.

4. The downlight apparatus of claim 1, wherein the bottom plate of the driver box does not have the same shape as the top part of the light source container.

5. The downlight apparatus of claim 4, wherein the bottom plate of the driver box does not completely cover the top part of the light source container so as to expose a portion of the top part of the light source container.

6. The downlight apparatus of claim 1, wherein the lateral wall of the light source container has a fixing structure for installing a pair of elastic structures to fix the downlight apparatus to a ceiling.

7. The downlight apparatus of claim 1, wherein the side wall of the driver box has a round corner.

8. The downlight apparatus of claim 1, wherein the bottom plate is a rectangular shape.

9. The downlight apparatus of claim 8, wherein the top part of the light source container is a circular shape.

10. The downlight apparatus of claim 1, wherein the top part of the light source container has an alignment structure to be aligned with the driver box.

11. The downlight apparatus of claim 1, wherein the conductive path comprises a plugging structure for electrically connecting the driver circuit to the LED chips by plugging.

12. The downlight apparatus of claim 1, wherein the driver box is detachable to be replaced with another different driver box.

13. The downlight apparatus of claim 1, wherein the top cover has two levers sliding within two corresponding grooves of the side wall of the driver box when the top cover is rotated with respect to the side wall.

14. The downlight apparatus of claim 1, further comprising a wire fixing structure disposed on the side wall of the driver box for fixing a wire connected to the driver circuit and extends outside the driver box.

15. The downlight apparatus of claim 14, wherein the wire fixing structure is a separate component plugging into a socket of the side wall of the driver box.

16. The downlight apparatus of claim 15, wherein the wire fixing structure has an elastic clip for clipping the wire to prevent the wire to move with respect to the driver box.

17. The downlight apparatus of claim 1, further comprising a heat sink attached on the side wall extended to the lateral wall of the light source container.

18. The downlight apparatus of claim 1, wherein the main housing is made of plastic material.

19. The downlight apparatus of claim 1, wherein the light source plate is fixed to a bottom side of the top part of the light source plate.

20. The downlight apparatus of claim 1, wherein the driver box further contains a wireless circuit, the wireless circuit and the driver circuit are disposed on two circuit boards.
